(19) United States
(12) Patent Application Publication
(10) Pub. No.: US 2014/0161274 A1
(43) Pub. Date: Jun. 12, 2014

(54) Dual-Mode Wire/Wireless Headphone with Wireless Audio Gateway Functionalities to Support Multiple Wireless Headphones

(71) Applicant: SilverPlus, Inc., Irvine, CA (US)

(72) Inventors: Suresh Singamsetty, Aliso Viejo, CA (US); Dennis Kwan, San Diego, CA (US); Jefferson Hu, Corona, CA (US); Jeffrey Hsieh, Dove Canyon, CA (US)

(73) Assignee: SilverPlus, Inc., Irvine, CA (US)

(21) Appl. No.: 14/101,527

(22) Filed: Dec. 10, 2013

Related U.S. Application Data
(60) Provisional application No. 61/735,247, filed on Dec. 10, 2012.

(51) Int. Cl. H04R 1/10

(52) U.S. Cl. CPC H04R 1/1058
USPC 381/74

(57) ABSTRACT

This disclosure provides a wired and wireless headphone device and method which supports the selective attachment to an audio source of one or more additional wireless headphones. The elements include a base headphone, an audio gateway device with transceiver, antenna controls, a battery, an audio connector for attachment to an audio source. In wireless mode, the base headphone operates as a single headphone. In audio gateway mode, the base headphone operates as a wired headphone and as an audio gateway for one or more additional wireless headphones receiving the same audio source as the base headphone. The key advantages of this device and method are the elimination of a standalone audio gateway box and ability to add more wireless headphones using dynamic audio coding selection.

This application claims priority to U.S. provisional patent application Ser. No. 61/735,247 filed Dec. 10, 2012, which is owned by a common assignee, and which is herein incorporated by reference in its entirety.

### BACKGROUND

1. Technical Field

The present disclosure generally relates to the field of wireless headphones. More particularly, this disclosure relates to an apparatus and method for connecting multiple wireless headphones to a wired headphone/gateway which is attached to an audio source.

2. Description

The sharing of music among two or more listeners is valued by consumers. Current solutions are add-on gateways that send audio streams over Bluetooth (a wireless technology standard for exchanging data over short distances (using short-wavelength radio transmissions in the ISM band from 2400-2480 MHz)). Existing products can support a maximum of two Bluetooth headsets. Mobile phones themselves do not support broadcast to multiple devices.

U.S. Pat. No. 6,978,163 B2—Multi-Purpose Donale for Wireless Headset (Dyer et al.) provides devices for storing, transporting, and recharging wireless headsets and associated devices.

U.S. Pat. No. 8,131,391 B2—Wireless Digital Audio Music System (Woolfork) includes a portable audio source with a digital audio transmitter and an audio receiver coupled to a headphone set.

U.S. Pat. No. 8,126,157 B2—Apparatus and Method for Sharing Contents Via Headphone Set (Buil et al.) relates to a verification system which allows multiple users to share audio content.

U.S. Pat. No. 7,908,442 B2—Memory Management Method and System (Tan) describes a method and a system that enables wireless sharing of audio sounds among a plurality of users.

U.S. Patent Application 20120275618 A1—Wireless sharing of audio files and related information (Chan) provides a system and a method for wireless sharing of audio sounds among a plurality of users.

### Web Links:

1) “Forget Swapping Headphones, MyStream lets you share music wirelessly”
http://venturebeat.com/2011/03/31/mystream-launch/SP

### SUMMARY

It is an objective of this disclosure to provide a wired and wireless headphone device and method which supports the selective attachment to an audio source of one or more additional wireless headphones.

The objects of this disclosure are achieved by a base headphone, an audio gateway device with transceiver, antenna controls, a battery, and an audio connector for attachment to an audio source. In wireless mode, the base headphone operates as a single headphone. In audio gateway mode, the base headphone operates as a wired headphone and as an audio gateway for one or more additional wireless headphones receiving the same audio source as the base headphone.

The marketplace needs enhancements such as support for more than 2 wireless headphones, less interference from base mobile phone operation, light weight wireless headphone gateways, and graceful degradation of audio quality as more wireless headphones are added.

### BRIEF DESCRIPTION OF THE DRAWINGS

FIG. 1 shows the elements of disclosure with base headphone unplugged, operating in wireless headset mode.

FIG. 2 shows the base headphone plugged into mobile phone audio source and operating in wireless audio gateway mode.

FIG. 3a shows a block diagram which supports the dynamic addition of additional headphones.

FIG. 3b shows detail of the Audio Parameter Determination Block.

FIG. 4 gives a simplified message sequence in switching from two to three headphones attached to the audio gateway.

FIG. 5 shows an ergonomic diagram of the first headphone audio gateway device embodiment of this disclosure.

FIG. 6 shows a 2^{nd} embodiment with battery near headphone audio connector.

FIG. 7 shows a 3^{rd} embodiment with a microphone built into the gateway unit.

### DETAILED DESCRIPTION

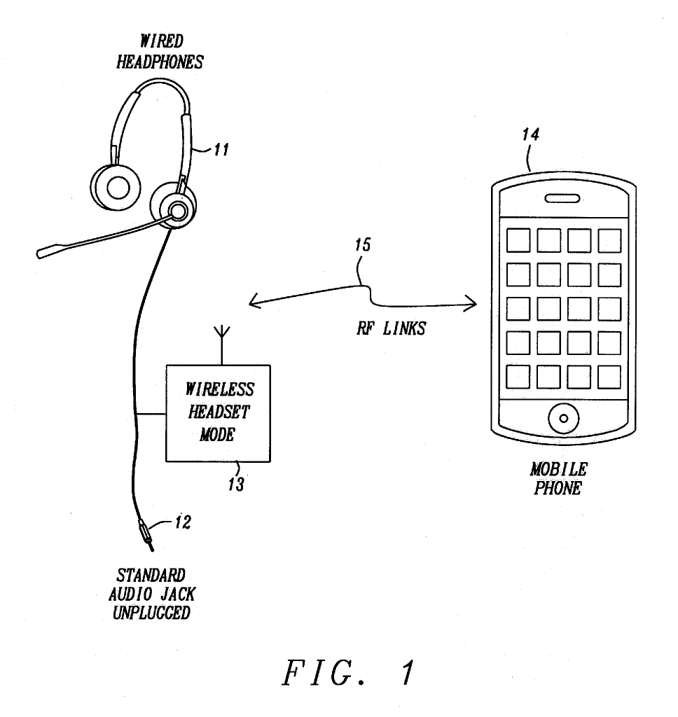

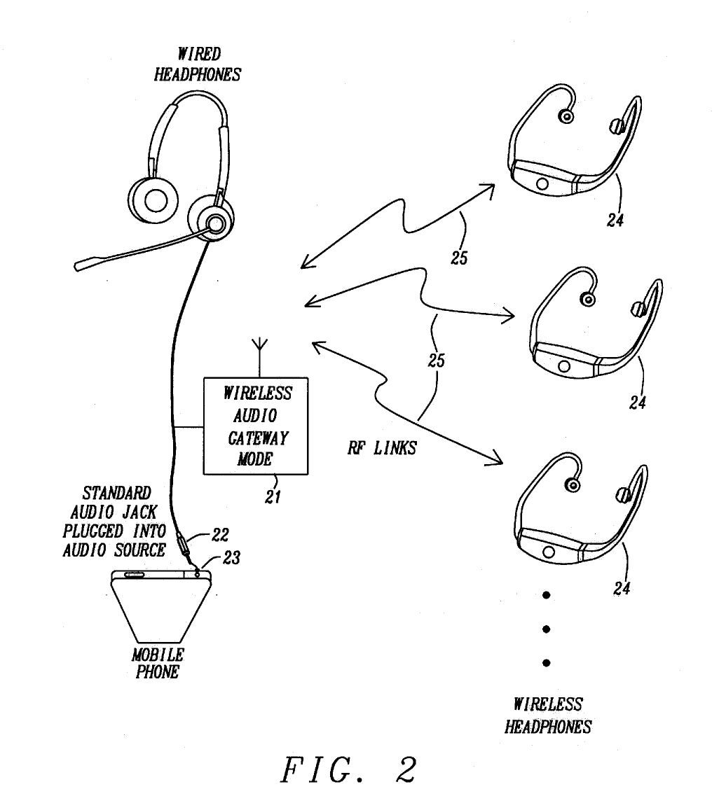

FIG. 1 shows the system concept of the present disclosure, when the headphone 11 is unplugged 12 and it operates as a conventional wireless headset and connects to an audio source such as a mobile phone 14 over Bluetooth. The headphone 11 of the first embodiment has a circuit device 13 which switches between wireless headset mode (when the audio jack is unplugged) and audio gateway mode shown in FIG. 2.

FIG. 2 shows the system when the headphone is plugged into an audio source such as a mobile phone. It is shown on the left as logically a wired headphone plugged into the standard analog audio jack 23 of a mobile phone, and the same audio signal is also routed to a wireless audio gateway 21 which then distributes the audio signals to one or more wireless headphones 24 over RF (radio frequency—3 kHz to 300 GHz) links 25. The device automatically detects the audio jack 22 being plugged into the mobile phone by either detecting the DC bias voltage at the microphone connection, or the presence of audio signals at the speaker connection.

The number of wireless headphones that can be supported by the audio gateway is limited by the total data throughput of the RF link, and a hard limit would be placed if each headphone uses a fixed data rate. This disclosure allows adding more users by using lower bit rate audio coding, and reducing from stereo to mono audio. For example over Bluetooth with 1 or 2 users, high quality SBC (Subband Codec, which is an audio encoder/decoder to connect Bluetooth high quality audio devices like headphones or loudspeakers) can be used, which can be reduced significantly by using 8 kHz PCM (Pulse Code Modulation) over SCO (Synchronous Connection Oriented link, a Bluetooth master/slave data link type) channels to support higher number of users. This is entirely useable for listening to voice-only content, for example, such as talk shows or news.

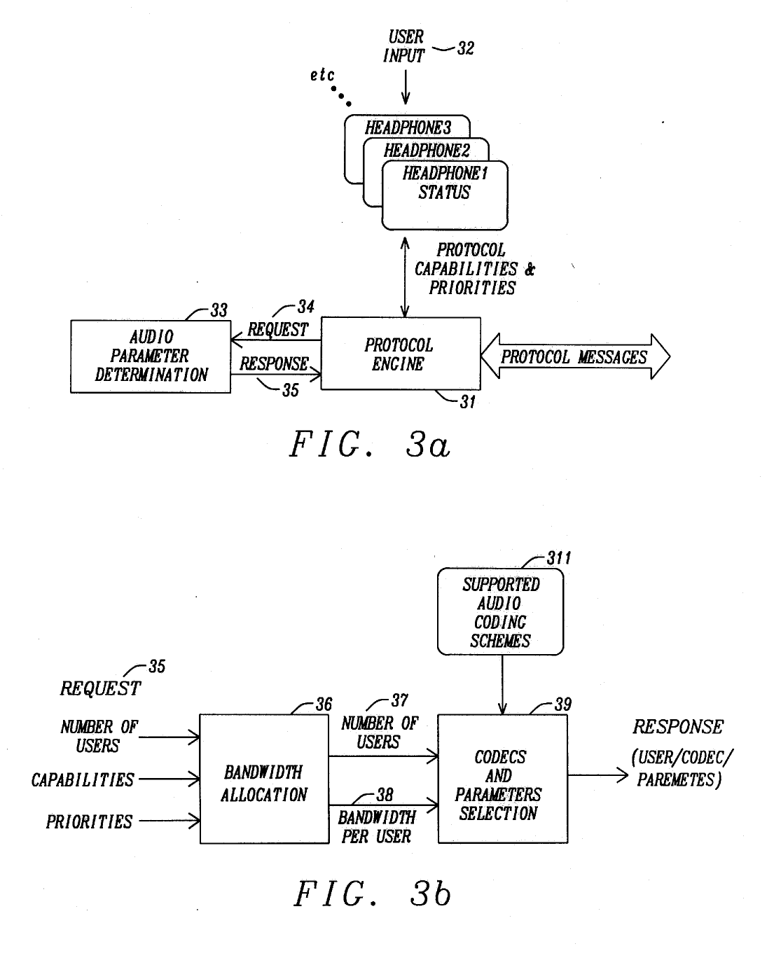

For Bluetooth, the typical products use stereo SBC encoding at high quality requiring data rate of around 345 kbps, which results in a maximum of just two headphones. If the quality can be reduced to mono at lower quality, the data rate can be reduced to 127 kbps, which means the number of headphones can be more than doubled to 4 or 5. Instead of a hard limit on the number of headphones, a dynamic configuration scheme can be implemented as shown in the block diagram of FIG. 3a.

The protocol engine 31 implements the logic for processing of incoming messages and generation of outgoing messages, conforming to the requirements of the specific protocols being implemented, such as AVDTP (Audio/Video Distribution Transport Protocol, used by one or more of the Bluetooth profiles that specifies at least one aspect of Bluetooth-based wireless communication between devices). It keeps a record of the status of all headphones that are connected with the audio gateway, which consists of the states of connection that each headphone are in, their capabilities and the priorities which are assigned to them. Such priorities are not part of the wireless protocol but determined arbitrarily by the application, as represented as User Input 32 in the diagram. For example the audio gateway (User) may determine that the first two connected headphones be given high priority while all subsequent ones are low priority. Whenever a change occur to the headphone status records, the Protocol Engine 31 needs to determine new audio parameters based on some evaluation logic, which is represented as the Audio Parameter Determination block 33 which accepts requests 34 from and generate responses 35 to the Protocol Engine. A more detailed block diagram for the Audio Parameter Determination block is shown in FIG. 3b.

A request 35 would consist of the number of users (headphones), their individual capabilities and the priorities assigned to them. Based on these requirements, the optimal allocation of bandwidth for each user is then calculated by the Bandwidth Allocation Block 36 to give the number of users 37 and their individual bandwidth 38 that can be supported. For example, there could be three users with first two being equal priorities and their capabilities are high quality SBC only, while the 3^{rd} user has lower priority but support MP3 (encoding format for digital audio which uses lossy data compression) from 32 kbps to 128 kbps. The Bandwidth Allocation function determines that the Bluetooth channel can only support the first two users, so the output would be two users with their bandwidths being 345 kbps each, while the 3^{rd} user is given 50 kbps. The next block 39 then selects the audio codecs and parameters that would meet these requirements with the best achievable quality, based on the audio coding schemes 311 that can be supported simultaneously by the Audio Gateway in terms of its processing capabilities. In this example the final response could be user 1 and 2 given SBC at 345 kbps, while the 3^{rd} user given MP3 at 48 kbps.

A simple implementation of such a scheme can be a simple look up table that gives an audio coding scheme together with the parameters such as sampling frequency for any given number of headphones, an example of which is shown in the table below:

| Number of | | |
|---|---|---|
| Headphones | Coding Scheme | Parameters |
| 1 | SBC | 48 kHz sampling, 8-bands |
| 2 | SBC | 44.1 kHz, 4-bands |
| 3 | MP3 | 96 kbps |
| 4 | MP3 | 64 kbps |
| 5 | MP3 | 56 kbps |

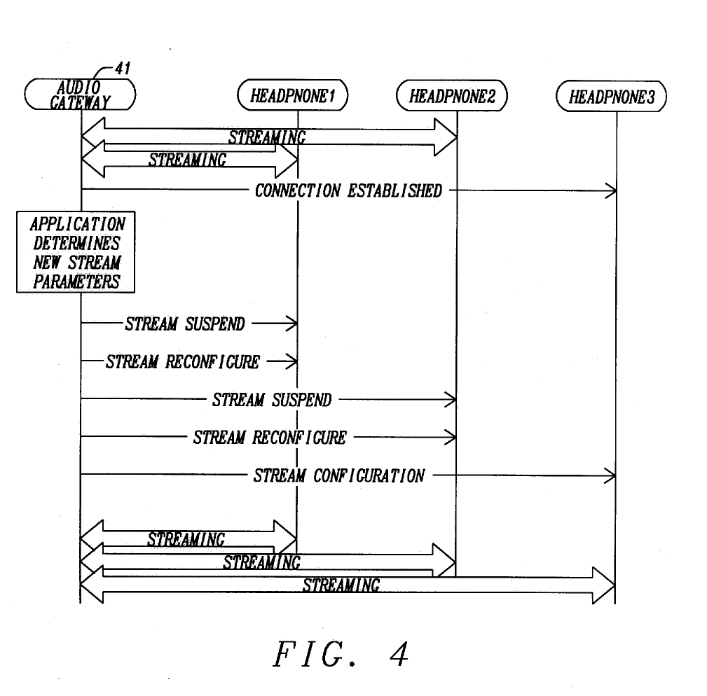

Regarding the processing of the protocol messages, this disclosure applies this concept to the particular usage model of the wireless audio gateway, whereby the number of headphones can be changed dynamically as users join and leave the group sharing the audio stream, as applies in a Bluetooth system where the headphones can connect and disconnect from the audio gateway at will (provided that the headphones are already paired with the audio gateway). A typical application of this disclosure using the Bluetooth protocol would use the audio/video distribution protocols consisting of A2DP (Advanced Audio Distribution Profile, a Bluetooth profile defining audio streaming over a Bluetooth connection), AVDTP and GAVDP (Generic Audio/Video Distribution Profile). FIG. 4 shows an example of a simplified message sequence chart using procedures and messages supported by AVDTP and GAVDP, whereby the audio gateway is initially streaming audio to headphones 1 and 2, when headphone 3 establishes a new connection with audio gateway 41. Audio gateway then determines the new parameters that would support all three headphones, after which it performs a parameter change procedure to each of headphones 1 and 2 by exchanging protocol messages for stream suspend and stream reconfigure, and also stream configuration to headphone 3. Streaming to all three headphones can then continue. The protocol is very light weight and the whole process can be done in well under 1 second, enabling the addition and removal of headphones to be minimally disruptive to other users.

It should also be noted that the parameters need not be the same for all headphones, especially when they may have different audio coding capabilities. Thus the allocation of data bandwidth to each headphone can be made based on any prioritization schemes, including equal priorities, but in practice it will be primarily based on audio coding capabilities. The protocol for “Get Capabilities” is provided by AVDTP and is inherent during the connection establishment process shown in FIG. 4. [Please refer to AVDTP Specification V1.3, section 8.21.5 which defines the Media Codec Capabilities field within the AVDTP_GET_CAPABILITIES_RSP message defined in 8.7.2, being used in the Get Capabilities signaling procedure defined in 6.7]

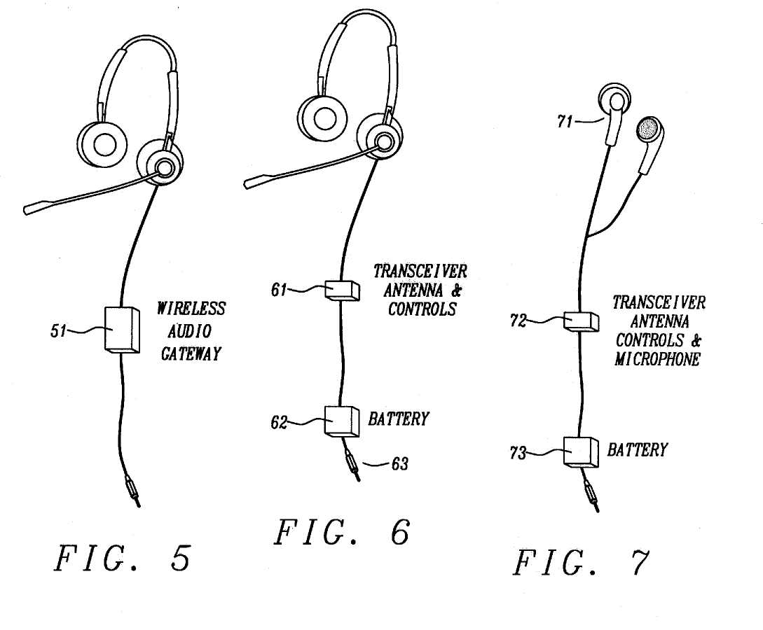

FIG. 5 shows a form factor for the one embodiment of the device, which can be much more ergonomic and that the wireless audio gateway 51 is integrated as part of the cable assembly.

FIG. 6 shows how another embodiment may encapsulate the battery 62 in a housing closer to the audio jack 63, and the RF transceiver, antenna and controls (e.g. push buttons) in a housing 63 closer to the headphones. This has the advantage of having the battery supported by the phone and reducing weight to the user, while maintaining the advantage of having greater RF isolation between the audio gateway and the phone.

FIG. 7 shows how a third embodiment may incorporate the microphone into the upper housing 72 together with the transceiver, antenna and the controls. This is illustrated in FIG. 7 which is similar to many headphones 71 with microphone and control in a small enclosure along the cable, except adding antenna and RF transceiver to the enclosure.

Key advantages of this device and method are include: 1) Combining wired headphones with the wireless audio gateway is convenient to the user compared to a standalone audio gateway device. Most mobile phone users carry wired headphones for listening to music, and the disclosure enables adding audio sharing capability without the inconvenience of carry another standalone audio gateway product.

2) Having one user, typically the owner of the mobile phone, using the wired headphones reduces the wireless data capacity requirement, especially for Bluetooth which does not have a means to support audio broadcast to multiple slaves. This increases by one the total number of users sharing the audio stream, and as the owner typically is physically close to the phone, it does not incur any significant inconveniences. 3) RF interference between the audio gateway and the mobile phone is significantly reduced due to the greater separation between the two. 4) Split housing for better weight distribution and ergonomics, and RF performance. Also, the use of low-power and miniaturization of RF electronics allows the audio gateway and battery to be compact without adding much weight to the headphones. 5) Dynamic audio coding selection with number of users allows more users to be supported. There is a graceful degradation of audio quality as more wireless headphones are added. Existing products placed hard limit of just one or two wireless headphones being supported at any one time. This disclosure allows adding more users by using lower bit rate audio coding, and reducing from stereo to mono audio.

While this disclosure has been particularly shown and described with Reference to the preferred embodiments thereof, it will be understood by those Skilled in the art that various changes in form and details may be made without Departing from the spirit and scope of this disclosure.

What is claimed is:

1. A headphone device which supports the selective attachment to an audio source of one or more additional wireless headphones, comprising:
a base headphone;
a dual mode device, connected to said base headphone, capable of operating in either a wireless headset mode or a wireless audio gateway mode; and
an audio connector also connected to said base headphone, for attachment to an audio source.

2. The headphone device of claim 1, wherein said wireless headset mode allows said base headphone to operate as a single wireless headphone.

3. The headphone device of claim 1, wherein said wireless audio gateway mode allows said base headphone to operate as a wired headphone, and provides an audio gateway capability for one or more additional wireless headphones to receive an audio signal from said audio source.

4. The headphone device of claim 1, wherein a battery is provided separately from said dual mode device and closer to said audio source than to said dual mode device.

5. The headphone device of claim 4, wherein said dual mode device comprises a transceiver antenna and controls, which are placed closer to said base headphone than said battery.

6. The headphone device of claim 1, wherein said dual mode device further comprises a base microphone, wherein said base headphone is a simple headphone without a built-in microphone.

7. The headphone device of claim 1 wherein said dual mode device comprises:
an audio parameter determination block; and
a protocol engine in communication with said audio parameter determination block;
wherein said audio parameter determination block and said protocol engine provide for dynamic configuration for one or more wireless headphones in communication with said dual mode device.

8. The headphone device of claim 7, wherein said audio parameter determination block and said protocol engine allow adding a flexible number of wireless headphones by varying audio coding bit rates among said wireless headphones.

9. The headphone device of claim 7, wherein said audio
parameter determination block and said protocol engine allow adding a flexible number of wireless headphones by varying whether said headphones are sent stereo or mono audio signals.

10. The headphone device of claim 7, wherein said audio
parameter determination block is capable of maintaining a list of supported audio schemes, codec parameter selection, and bandwidth allocation for each attached wireless headphone.

11. The headphone device of claim 7, wherein said protocol engine provides headphone status logic, which includes protocol states, headphone capabilities, and headphone priorities, and wherein said protocol engine provides external protocol messages used to communicate with said wireless headphones.

12. A method of providing a headphone device which supports the selective attachment to an audio source of one or more additional wireless headphones, comprising the steps of:
providing a base headphone;
connecting a dual mode device to said base headphone, capable of operating in either a wireless headset mode or a wireless audio gateway mode;
and
connecting an audio connector to said base headphone, for attachment to an audio source.

13. The method of providing a headphone device of claim 12, wherein said wireless headset mode allows said base headphone to operate as a single wireless headphone.

14. The method of providing a headphone device of claim 12, wherein said wireless audio gateway mode allows said base headphone to operate as a wired headphone, and provides an audio gateway capability for one or more additional wireless headphones to receive an audio signal from said audio source.

15. The method of providing a headphone device of claim 12, wherein a battery is provided separately from said dual mode device and closer to said audio source than to said dual mode device.

16. The method of providing a headphone device of claim 15, wherein said dual mode device comprises a transceiver antenna and controls, which are placed closer to said base headphone than said battery.

17. The method of providing a headphone device of claim 12, wherein said dual mode device further comprises a base microphone, wherein said base headphone is a simple headphone without a built-in microphone.

18. The method of providing a headphone device of claim 12 wherein said dual mode device comprises the steps of:
providing an audio parameter determination block; and
providing a protocol engine in communication with said audio parameter determination block;
wherein said audio parameter determination block and said protocol engine provide for dynamic configuration for one or more wireless headphones in communication with said dual mode device.

19. The method of providing a headphone device of claim 18, wherein said audio parameter determination block and said protocol engine allow adding a flexible number of wireless headphones by varying audio coding bit rates among said wireless headphones.

20. The method of providing a headphone device of claim 18, wherein said audio parameter determination block and said protocol engine allow adding a flexible number of wireless headphones by varying whether said headphones are sent stereo or mono audio signals.

21. The method of providing a headphone device of claim 18, wherein said audio parameter determination block is capable of maintaining a list of supported audio schemes, codec parameter selection, and bandwidth allocation for each attached wireless headphone.

22. The method of providing a headphone device of claim 18, wherein said protocol engine provides headphone status logic, which includes protocol states, headphone capabilities, and headphone priorities, and wherein said protocol engine provides external protocol messages used to communicate with said wireless headphones.

23. The method of providing a headphone device of claim 18 wherein said audio parameter determination block comprises the steps of:
receiving requests from said protocol engine, wherein said requests provide a number of users, audio capabilities of said users, and priorities of said users,
calculating optimal allocation of bandwidth for each of said users,
selecting audio codecs and parameters to meet said optimal allocation of bandwidth for said users.
